(19) United States
(12) Patent Application Publication
(10) Pub. No.: US 2004/0233629 A1
(43) Pub. Date: Nov. 25, 2004

(54) Memory stick, pen-base memory stick

(76) Inventors: Daniel Wang, Taipei (TW); Sunnie Lin, Taipei (TW)

Correspondence Address: BACON & THOMAS, PLLC, 625 SLATERS LANE, FOURTH FLOOR, ALEXANDRIA, VA, 22314

(21) Appl. No.: 10/847,382

(22) Filed: May 18, 2004

(30) Foreign Application Priority Data
May 20, 2003 (TW) 092209184
Dec. 4, 2003 (TW) 092221505

(51) Int. Cl. G06F 1/16

(52) U.S. Cl. 361/684

(57) ABSTRACT

A memory stick is constructed to include a memory module having an interface connectable to an I/O port of an electronic apparatus, and a container accommodating the memory module, the container having a clip at the periphery for fastening, an end cap detachably fastened to one end thereof to protect the interface of the memory module, and a connector provided at the other end thereof for the connection of a tool, for example, an envelopment knife, keyring, screwdriver, pen, laser pointer, lipstick, flash lamp, etc.

### BACKGROUND OF THE INVENTION

1. Field of the Invention

The present invention relates to a mobile memory device and more particularly, to a memory stick that can be conveniently carried on the body of the user.

2. Description of the Related Art

Previously, a computer user usually uses a floppy disk or compact disk for transferring storage data or files from one computer to another. Currently, people may directly send storage data or files from one computer to another by e-mail. However, it takes much time to send a huge amount of data by e-mail. Following fast development of computer technology, various mini mobile memory devices such as memory sticks and pen drivers have been disclosed and have appeared on the market. A mini mobile memory device is a plug-and-play device connectable to a USB port of a computer system. When connected a mini mobile memory device to a USB port of a computer system, the user can then transfer storage data from the computer system to the mini mobile memory device, or from the mini mobile memory device to the computer system.

FIG. 1 shows a pen driver 80 according to the prior art. According to this design, the pen driver 80 comprises a pen 81 and a memory module 82. The penholder of the pen 81 is formed of an upper barrel 83 and a lower barrel 84, and the ink cartridge and writing tip assembly 85 of the pen 81 is installed in the lower barrel 84. The memory module 82 is fixedly fastened to the upper barrel 83, having an interface 86 extended out of the upper barrel 83 and insertable into the lower barrel 84. When using the memory module 82 for storing data, the upper barrel 83 must be detached from the lower barrel 84. At this time, it is not practical to use the pen 81 for writing because it is not comfortable to hold the short lower barrel 84 with the hand for writing.

FIG. 2 is an exploded view of a memory stick 90 according to the prior art. According to this design, the memory stick 90 comprises a memory module 91, a hollow shell 92 adapted to accommodate the memory module 91, and cap 93 for closing the shell 92 to protect the memory module 91. When in use, the cap 93 is removed from the hollow shell 92, and then the interface 94 of the memory module 91 is plugged into an I/O (USB) port of the computer or the like. This design of memory stick has only the data storage function without any added value, providing low practical value and achieving low economic effect.

### SUMMARY OF THE INVENTION

The present invention has been accomplished under the circumstances in view.

It is one object of the present invention to provide a memory stick formed of a pen and a memory module, wherein the memory module is detachably fastened to the inside of the pen, and the pen is maintained in the same size for writing after removal of the memory module.

It is another object of the present invention to provide a memory stick formed of a memory module and a container, wherein the memory module is detachably fastened to the inside of the container, and the container is provided with a connector for connecting a tool, for example, an envelopment knife, keyring, screwdriver, pen, laser pointer, lipstick, flash lamp, etc.

According to one embodiment of the present invention, the memory stick comprises a memory module, the memory module comprising an interface and an outer shell, the outer shell having a first open end through which the interface extends to the outside for connection to an I/O port of an electronic apparatus and a second open end opposite to the first open end, and a plug member sealed to the second open end, the plug member having a tie hole for the fastening of a cord member; and a cap detachably fastened to the memory module to keep the interface from sight.

According to another embodiment of the present invention, the memory stick comprises a memory module, the memory module comprising an interface connectable to an I/O port of an electronic apparatus; and a container accommodating the memory module, the container comprising a first opening in a first end thereof, an end cap adapted to close the first opening, a second opening in a second end thereof, and a connector fastened to the second opening for the connection of a tool.

According to still another embodiment of the present invention, the memory stick comprises a memory module, the memory module having an interface connectable to an I/O port of an electronic apparatus; and a pen, the pen comprising a penholder, the penholder having a bottom end, a holding chamber, which accommodates the memory module, and a top opening, an ink cartridge and writing tip assembly fastened to the penholder and partially extended out of the bottom end of the penholder for writing, and a top cap detachably fastened to the penholder to close the top opening of the penholder.

### BRIEF DESCRIPTION OF THE DRAWINGS

FIG. 1 is an exploded plain view of a pen driver according to the prior art.

FIG. 2 is a perspective exploded view of a memory stick according to the prior art.

FIG. 3 is an exploded view of a memory stick according to one embodiment of the present invention.

FIG. 4 is a sectional assembly view of the memory stick shown in FIG. 3.

FIG. 5 is a sectional view of an alternate form of the memory stick according to the present invention.

FIG. 6 is a cross sectional view in an enlarged scale of the memory stick shown in FIG. 5.

FIG. 7 is a longitudinal view in section of another alternate form of the memory stick according to the present invention.

FIG. 8 is a schematic sectional view showing an envelopment knife fastened to the connector of at one end of the container according to the embodiment shown in FIG. 7.

FIG. 9 is a sectional view of still another alternate form of the memory stick according to the present invention.

FIG. 10 is a sectional view of still another alternate form of the memory stick according to the present invention.

FIG. 11 is an exploded view of the memory stick shown in FIG. 10.

FIG. 12 is an exploded view of still another alternate form of the pen driver according to the present invention.

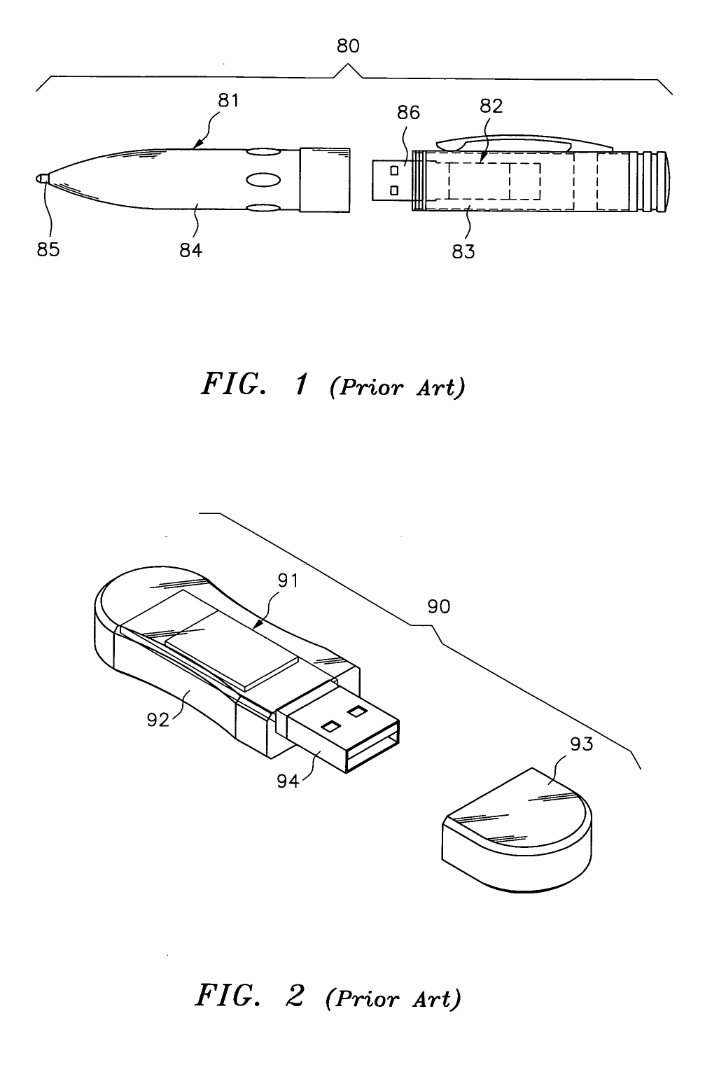

### DETAILED DESCRIPTION OF THE PREFERRED EMBODIMENT

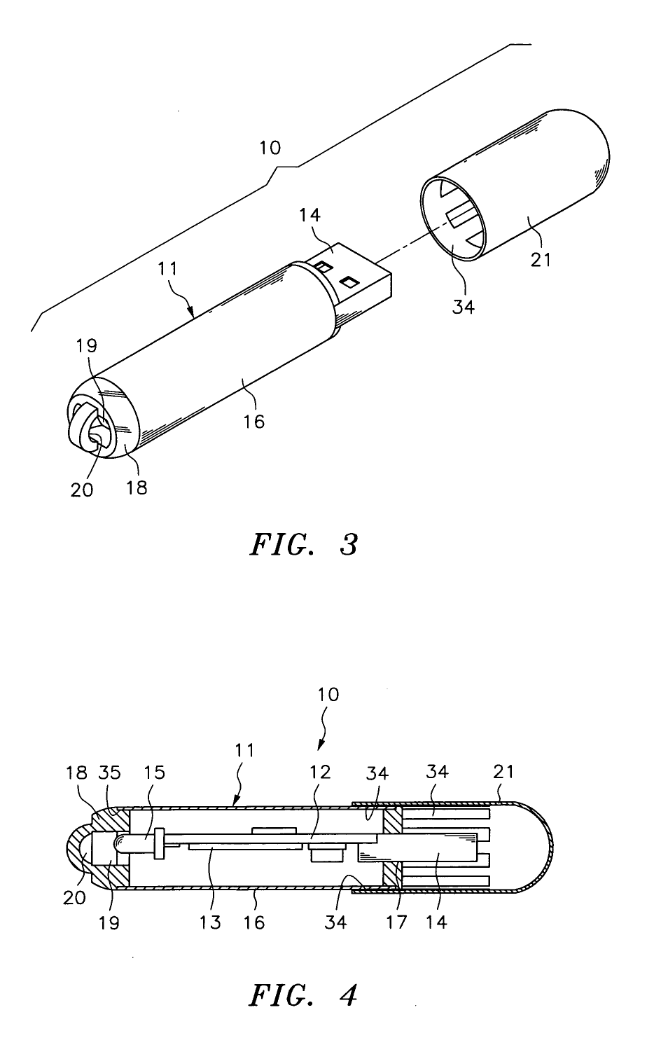

Referring to FIGS. 3 and 4, a memory stick 10 is shown comprised of a memory module 11 and a cap 21. The memory module 11 comprises a PC board 12, a memory 13 installed in the PC board 12, an interface 14, and a read write indicator light 15. The interface 14 is connectable to an I/O port of a computer system so that data can be copied from memory means of the computer system to the memory 13 of the memory stick 10 or from the memory 13 of the memory stick 10 to memory means of the computer system. This data copying technique is of the known art and not within the scope of the present invention, no further detailed description in this regard is necessary.

The memory module 11 further comprises an outer shell 16. The outer shell 16 an elongated hollow member having two opposite openings, namely, the first opening 17 at one end and the second opening 35 at the other end. The interface 14 extended through the first opening 17 to the outside of the memory module 11. The cap 21 is detachably attached to one end of the outer shell 16 to protect the interface 14 and to keep the interface 14 from sight, having a retaining spring member 34 situated on the inside. When capped the cap 21 on one end of the outer shell 16, the retaining spring member 34 is pressed against the periphery of the outer shell 16 to produce a friction resistance between the outer shell 16 and the cap 21, thereby securing the cap 21 to the outer shell 16. The second opening 35 is sealed with a plug member 18. The plug member 18 is made of transparent material that admits light from the read write indicator light 15. The plug 18 has a heat dissipation hole 19 for quick dissipation of heat from the memory module 11 to the outside open space, and a tie hole 20 through which the memory stick 10 can be fastened to a necklace, keyring, or the like.

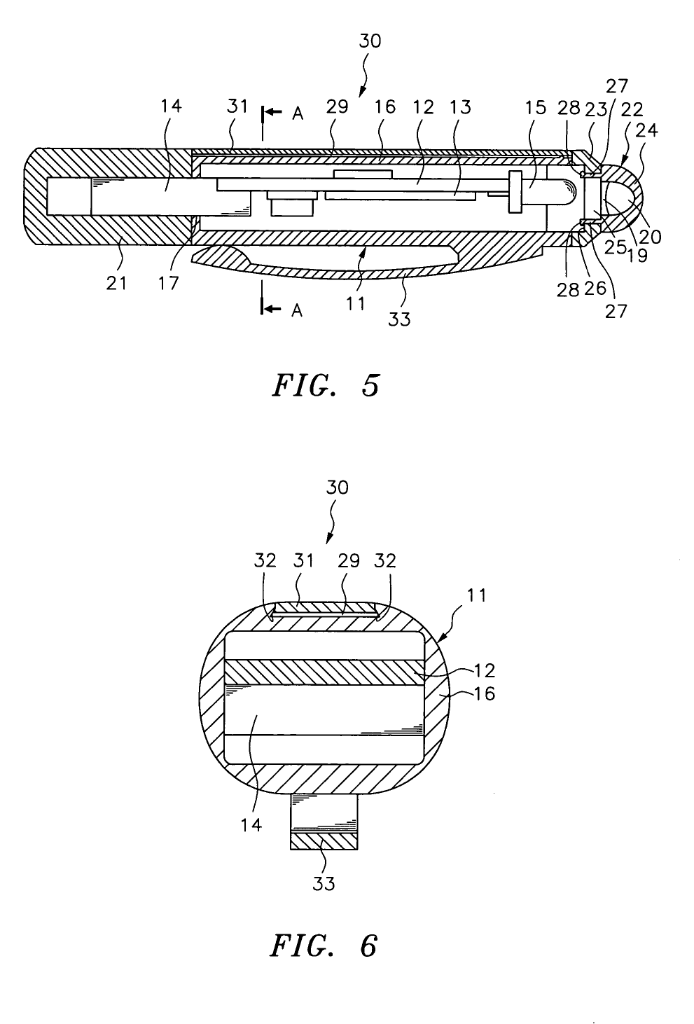

FIG. 5 is a sectional view of an alternate form of the present invention. This embodiment is substantially similar to the embodiment shown in FIGS. 3 and 4 with the exception of the design of the plug member. According to this embodiment, the plug member 22 of the memory stick 30 is comprised of a fixed member 23 and a movable member 24. The fixed member 23 is fixedly fastened to the outer shell 16, having an insertion hole 25 and a shoulder 26 around the inner end of the insertion hole 25. The movable member 24 has two springy coupling strips 27 bilaterally extended from the back side thereof. Each springy coupling strip 27 has the free end terminating in an outwardly protruded stop portion 28. By means of pressing the springy coupling strips 27 toward each other and then inserting the springy coupling strips 27 into the insertion hole 25 of the fixed member 23, the stop portions 28 of the springy coupling strips 27 are coupled to the shoulder 26 to secure the movable member 24 to the fixed member 23, allowing free rotation of the movable member 24 in the insertion hole 25. The movable member 24 further comprises a heat dissipation hole 19 for quick dissipation of heat from the memory module 11 to the outside open space, and a tie hole 20 through which the memory stick 30 can be fastened to a necklace, keyring, or the like. Alternatively, an ornament may be fastened to the movable member 24 to decorate the memory stick 30. The outer shell 16 of the memory stick 30 has a flat recess 29 and two locating grooves 32 at two sides of the flat recess 29, and a transparent cover plate 31 is detachably fastened to the locating grooves 32 to hold down a sheet member, for example, a photo, nameplate, advertising printed matter, etc. on the flat recess 29 (see FIG. 6). The memory stick 30 further comprises a clip 33 formed integral with the outer shell 16 for fastening.

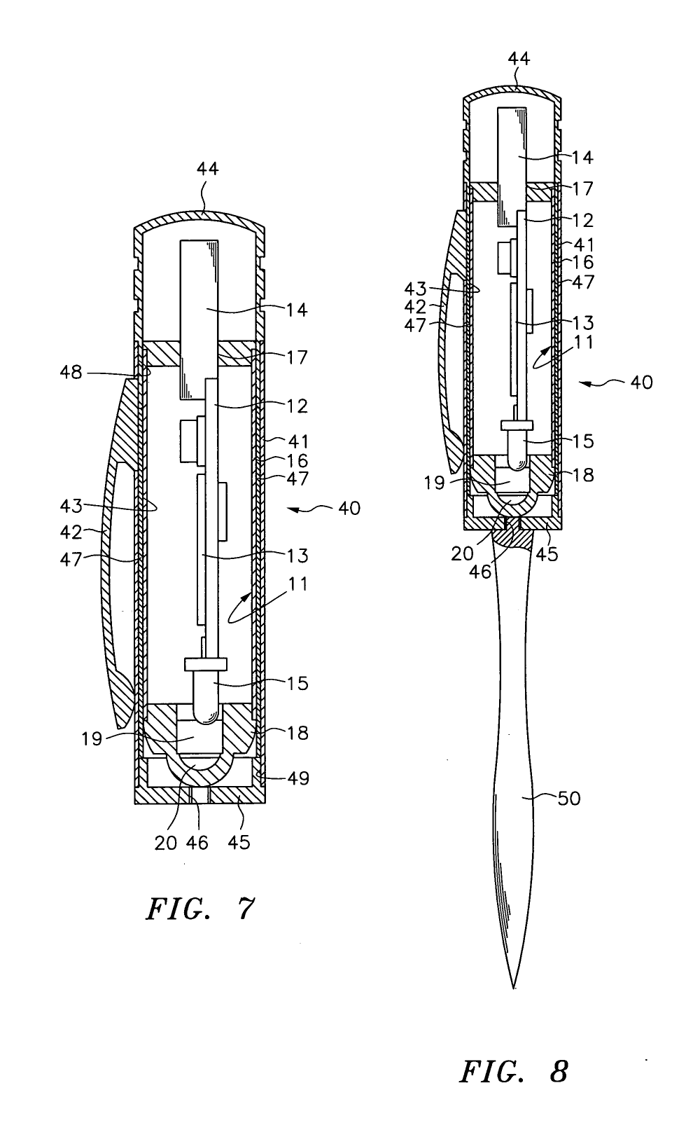

FIG. 7 shows another alternate form of the present invention. According to this embodiment, the memory stick 40 is comprised of a memory module 11 and a container 41. The memory module 11 is substantially same as the embodiment shown in FIG. 3. The container 41 is a hollow cylindrical member having a holding chamber 43, which accommodates the memory module 11, a clip 42 provided at the periphery for fastening, a first open end 48 through which the interface 14 of the memory module 11 extends out of the holding chamber 43, an end cap 44 detachably fastened to the first open end 48 to protect the interface 14 and to keep the interface 14 from sight, a second open end 49, and a connector 45 fastened to the second open end 49. The connector 45 has a thread 46 for the connection of a tool 50 (see FIG. 8). According to this embodiment, the tool 50 is an envelopment knife having a file formed integral with one side thereof.

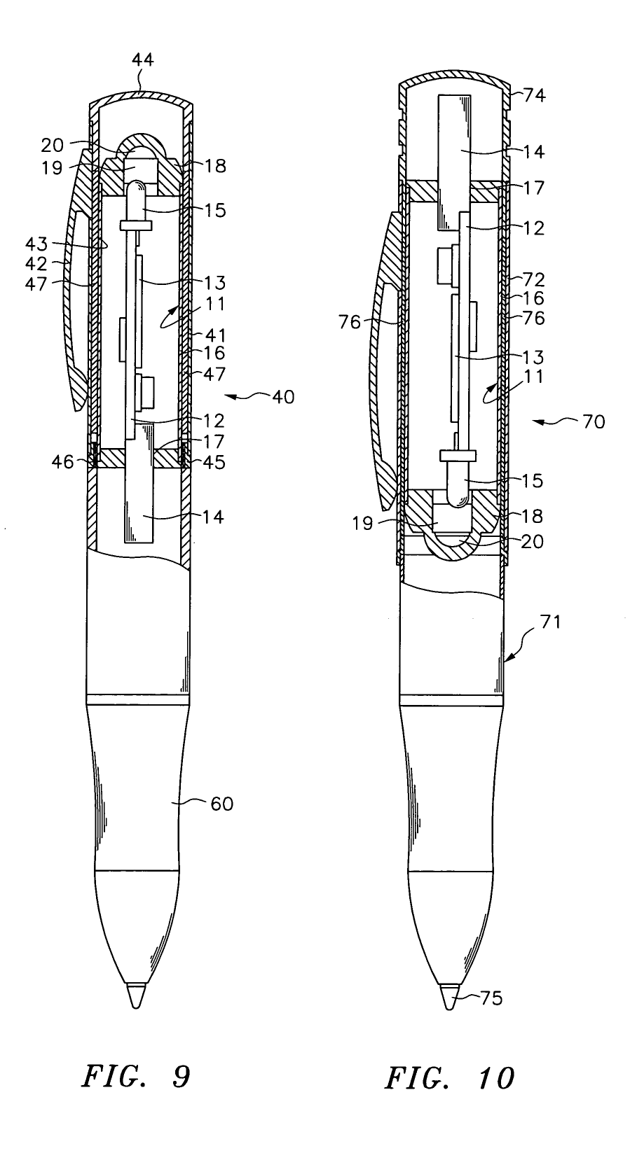

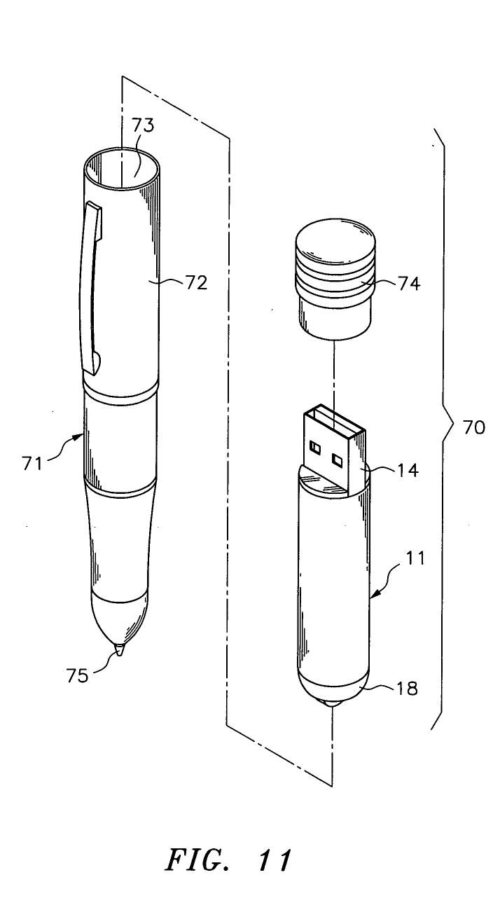

FIG. 9 shows still another alternate form of the memory stick according to the present invention. This embodiment is substantially similar to the embodiment shown in FIG. 7 with the exception of the reversed positioning direction of the memory module 11 in the container 41. According to this embodiment, the connector 45 is a hollow member through which the interface 14 extends to the outside of the memory stick 40 for connection to an I/O port of a computer system. The tool 60, which is fastened to the thread 46 of the connector 45, is a pen. Further, the end cap 44 can be having a tip (not shown) for operating the display screen of a PDA or touch panel for data input. Any of a variety of tools or other devices such as keyring, laser pointer, screwdriver, lipstick, flash lamp, etc., may be made connectable to the connector 45.

In the embodiments shown in FIGS. 7-9, the container 41 comprises a retaining spring member 47 on the inside wall for securing the memory module 11 by a friction force. Therefore, the memory module 11 can conveniently detachably mounted in the container 41.

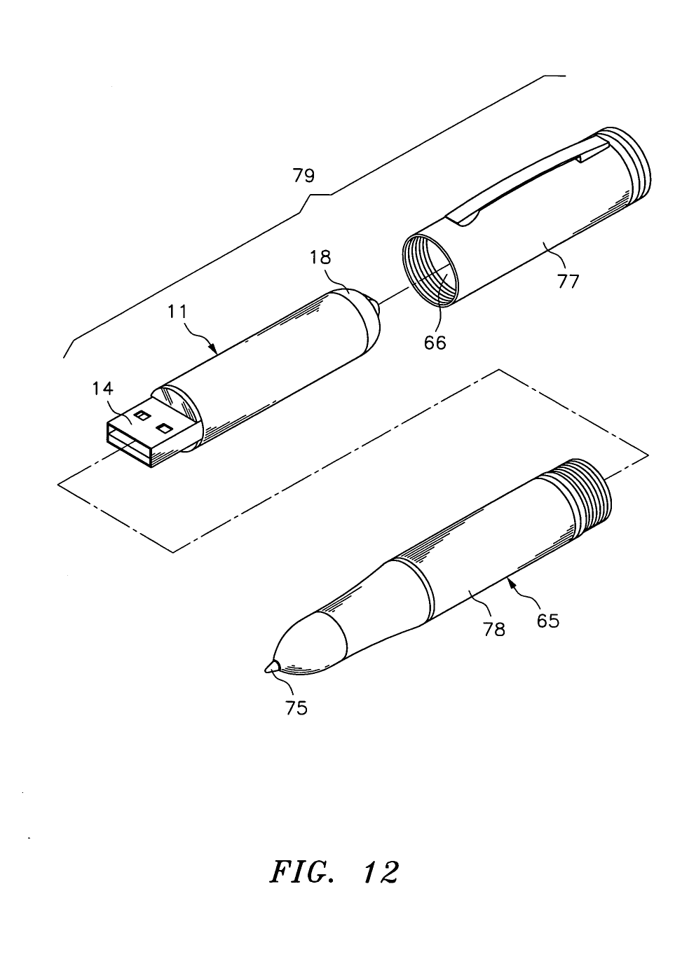

FIGS. 10 and 11 show still another alternate form of the present invention. According to this embodiment, the memory stick 70 comprises a memory module 11 and a pen 71. The memory module 11 is substantially similar to the aforesaid various embodiments. The pen 71 comprises a barrel 72 adapted to accommodate the memory module 11, an ink cartridge and writing tip assembly 75 mounted in the barrel 72 and extended out of one end of the barrel 72 for writing, and a top cap 74 detachably fastened to the other end, namely, the top open end 73 of the barrel 72 to protect the memory module 11. The barrel 72 has an inside wall mounted with a retaining spring member 76 adapted to secure the memory module 11 to the inside of the barrel 72 by a friction force.

The barrel 72 has sufficient inside space to accommodate the memory module 11, therefore the pen 71 works normally as a writing apparatus for writing either with the memory module 11 mounted inside the barrel 72 or without the memory module 11 in the barrel 72.

FIG. 12 shows still another alternate form of the present invention. According to this embodiment, the memory stick 79 is comprised of a pen 65 and a memory module 11. The memory module 11 is substantially similar to the aforesaid various embodiments. The pen 65 is comprised of a lower barrel 78, an ink cartridge and writing tip assembly 75 mounted in the lower barrel 78 and partially extended out of one end of the lower barrel 78 for writing, and an upper barrel 77 fastened to the other end of the lower barrel 78. The upper barrel 77 has a receiving chamber 66 adapted to accommodate the memory module 11. The memory module 11 is detachably mounted in the receiving chamber 66 of the upper barrel 77. After connection of the upper barrel 77 to the lower barrel 78, the pen 65 is used for writing.

Although particular embodiments of the invention have been described in detail for purposes of illustration, various modifications and enhancements may be made without departing from the spirit and scope of the invention.

What the invention claimed is:

1. A memory stick comprising:
a memory module, said memory module comprising an interface and an outer shell, said outer shell having a first open end through which said interface extends to the outside for connection to an I/O port of an electronic apparatus and a second open end opposite to said first open end, and a plug member sealed to said second open end, said plug member having a tie hole for the fastening of a cord member; and
a cap detachably fastened to said memory module to keep said interface from sight.

2. The memory stick as claimed in claim 1, wherein said plug member comprises a fixed member affixed to said memory module, and a swivel member coupled to said fixed member; said tie hole is formed in said swivel member.

3. The memory stick as claimed in claim 1, wherein said outer shell comprises a flat recess adapted to accommodate a flat member, and a transparent cover detachably closed on said flat recess to hold a flat member in said flat recess.

4. The memory stick as claimed in claim 1, wherein said plug member admits light and, has a heat dissipation hole.

5. The memory stick as claimed in claim 2, wherein said fixed member admits light; said swivel member is provided with an ornament.

6. The memory stick as claimed in claim 3, wherein said outer shell comprises a clip for fastening.

7. A memory stick comprising:
a memory module, said memory module comprising an interface connectable to an I/O port of an electronic apparatus; and
a container accommodating said memory module, said container comprising a first opening in a first end thereof, an end cap adapted to close said first opening, a second opening in a second end thereof, and a connector fastened to said second opening for the connection of a tool.

8. The memory stick as claimed in claim 7, wherein said connector comprises a thread for the connection of a tool.

9. The memory stick as claimed in claim 7, wherein said interface extends out of said container through said first opening; said end cap is adapted to close said first opening and to keep said interface from sight.

10. The memory stick as claimed in claim 7, wherein said connector is a hollow member through which said interface extends to the outside of said container.

11. The memory stick as claimed in claim 7, wherein said container comprises a clip for fastening.

12. The memory stick as claimed in claim 7, wherein said end cap comprises a protruding tip.

13. The memory stick as claimed in claim 7, further comprising a tool fastened to said connector.

14. A pen-base memory stick comprising:
a memory module, said memory module having an interface connectable to an I/O port of an electronic apparatus; and
a pen, said pen comprising a penholder, said penholder having a bottom end, a holding chamber, which accommodates said memory module, and a top opening, an ink cartridge and writing tip assembly fastened to said penholder and partially extended out of the bottom end of said penholder for writing, and a top cap detachably fastened to said penholder to close said top opening of said penholder.

15. The pen-base memory stick as claimed in claim 14, wherein said interface of said memory module extends out of said holding chamber through said top opening of said penholder and kept from sight by said top cap.

16. The pen-base memory stick as claimed in claim 14, wherein said penholder is comprised of a lower barrel and an upper barrel; said holding chamber is defined in said upper barrel.

17. A pen-base memory stick comprising:
a memory module, said memory module having an interface connectable to an I/O port of an electronic apparatus; and
a pen, said pen comprising a penholder, said penholder having a bottom end and a top end, an ink cartridge and writing tip assembly fastened to said penholder and partially extended out of the bottom end of said penholder for writing, and a top cap detachably fastened to the top end of said penholder, said top cap defining a holding chamber, which accommodates said memory module.
